(19) United States
(12) Patent Application Publication
(10) Pub. No.: US 2026/0155890 A1
(43) Pub. Date: Jun. 4, 2026

(54) METHOD FOR BEAM ALIGNMENT IN OPTICAL WIRELESS COMMUNICATION SYSTEMS

(71) Applicant: SIGNIFY HOLDING B.V., EINDHOVEN (NL)

(72) Inventor: ALEKSANDAR SEVO, EINDHOVEN (NL)

(21) Appl. No.: 19/122,285

(22) PCT Filed: Oct. 10, 2023
(86) PCT No.: PCT/EP2023/077969

§ 371 Date: Apr. 18, 2025

(30) Foreign Application Priority Data
Oct. 20, 2022 (EP) 22202787.2

(51) Int. Cl. H04B 10/116; G02B 17/06; H04B 10/112

(52) U.S. Cl. CPC H04B 10/116; G02B 17/06; H04B 10/1121

(57) ABSTRACT

An optical wireless communication system (100) comprising: an optical transmitter (200) comprising: a light source (210) configured to emit a beam for optical data communication; a subsystem (220) configured to carry out a beam alignment procedure based on incident light received from a remote optical receiver (300); and the remote optical receiver (300) comprising: a photo detector (310) configured to detect the beam sent by the optical transmitter (200); a half spherical mirror (320) configured to reflect part of the beam received from the optical transmitter (200) to assist the beam alignment procedure carried out by the optical transmitter (200).

### FIELD OF THE INVENTION

The invention relates to the field of free space optical wireless communication. More particularly, various methods, apparatus, systems, and computer-readable media are disclosed herein related to a method for beam alignment in optical wireless communication systems.

### BACKGROUND OF THE INVENTION

To enable more and more electronic devices like laptops, tablets, and smartphones to connect wirelessly to the Internet, wireless communication confronts unprecedented requirements on data rates and also link qualities, and such requirements keep on growing year over year, considering the emerging digital revolution related to Internet-of-Things (IoT). Radio frequency technology like Wi-Fi has limited spectrum capacity to embrace this revolution. In the meanwhile, light fidelity (Li-Fi) is drawing more and more attention with its intrinsic security enhancement and capability to support higher data rates over the available bandwidth in visible light, Ultraviolet (UV), and Infrared (IR) spectra.

However, to establish a point-to-point optical wireless communication link with a high data rate over a large separate distance, the optical wireless communication system or Li-Fi system is usually of narrow beam angles (in the order of a few degrees), resulted from the properties of light sources as well as a practical power budget. Furthermore, to achieve such a high-speed link reliably, the two remote communication devices need to be aligned precisely, which may be quite challenging due to the combination of the narrow beam width and the large separation. To assist this alignment, different methods have been proposed, such as with the aid of a camera, a pilot light from the remote device, or to use feedback information from the remote device. These systems suffer from either a long latency to reach a final alignment or additional complexity to the system.

For example, in a pilot light based beam alignment system, the pilot light is usually placed in front of a photo detector in the optical receiver. The surface of the pilot light shall be much smaller than the surface of the photo detector. However, to support high data rate, the photo detector needs small surface to obtain low parasitic capacitance. Thus, the requirement is difficult to satisfy in practice, or it may result in negative impact on the bandwidth to be supported by the data link.

U.S. Pat. No. 8,160,452B1 relates to an acquisition, pointing and tracking system for free space optical communications systems performs the pointing and tracking function internally by way of translating an internal optical fiber in the focal plane of the transceiver telescope with a reflecting mirror in the telescope focal plane of each linked transceiver.

US2002033981A1 relates to an optical communication transmitter, receiver, and transceiver having distinctive retro-reflective elements and/or reflectivity that can be modulated.

EP1191715A2 relates to an optical wireless network system comprising a transmitter including a laser for generating a light beam that is reflected from a micromirror toward a receiver; the receiver including a lens for receiving the incident light and directing the light to a photodiode; and a reflective ring surrounds the lens at the receiver, to reflect light back to the transmitter.

CN113176534A relates to a Gaussian beam tracking method based on Free Space Optical (FSO) communication.

### SUMMARY OF THE INVENTION

Given the limitation of a conventional pilot light based system, it is proposed in this invention to deploy a half spherical mirror in a target device to reflect part of the beam received from the optical transmitter to assist a beam alignment procedure in the optical transmitter, such that the beam reflected from the target device is used as a kind of pilot light as in a conventional system.

More particularly, the goal of this invention is achieved by an optical wireless communication system as claimed in claim 1, by a method of an optical wireless communication system as claimed in claim 8, and by an optical receiver as claimed in claim 10.

In accordance with a first aspect of the invention an optical wireless communication system is provided. An optical wireless communication system comprises:
an optical transmitter comprising:
a light source configured to emit a beam for optical data communication;
a subsystem configured to carry out a beam alignment procedure based on incident light received from a remote optical receiver; and
the remote optical receiver comprising:
a photo detector configured to detect the beam sent by the optical transmitter;
a half spherical mirror configured to reflect part of the beam received from the optical transmitter to assist the beam alignment procedure carried out by the optical transmitter;
   wherein the half spherical mirror is semi-transparent and semi-reflective, and the photo detector is placed behind the half spherical mirror with regard to an incident direction of the beam and at the center of the half-sphere.

The light source of the optical transmitter may be one of a light-emitting diode (LED), a laser diode, or a vertical-cavity surface-emitting laser (VCSEL). The optical data communication is carried out in an optical band, such as in visible light, Ultraviolet (UV), and Infrared (IR) spectra. The optical data communication may be according to an optical wireless communication standard. For example, the system may be compliant to an IEEE 802.11 standard (e.g., IEEE 802.11bb) or an ITU G. 9991 standard regarding high-speed optical wireless data communication.

The photo detector of the optical receiver is a semiconductor device that coverts light into electric current or voltage based on an operation mode of the device. The photo detector may also be called a photodiode, a light detector, or a photo sensor. The photo detector may contain optical filters, built-in lenses, and may have large or small surface areas. Depending on the construction of the device, photo detectors can be classified into different types, such as PN photodiode, Schottky photodiode, PIN photodiode, and Avalanche photodiode.

The beam alignment is implemented at the transmitter side, with the assistant of a reflected beam from a remote receiver.

For the high-speed optical wireless communication addressed in the present invention, it is preferably that the optical transmitter has a small beam angle. Beam angle or beam width is the aperture angle from where most of the transmission power is radiated. For example, the half power beam width is the angle between the half-power (−3dB) points of the main lobe of the radiation pattern. For the horizontal plane, beam angle or beam width is usually expressed in degrees. It is preferable that the beam angle of the optical transmitter is not larger than 30 degrees. And even more beneficially, the narrow beam is not larger than 10 degrees half-angle. Such narrow beam is of practical consideration to support long distance and high data rate communication within a reasonable power budget.

In a system with bi-directional optical wireless communication, the two remote devices may have both transmitting and receiving capabilities. Hence, a first device may have an optical transmitter according to the present invention and a conventional receiver, and a second device may have a conventional transmitter and an optical receiver according to the present invention. It may also be an option that both devices comprised the optical transmitter and the optical receiver according to the present invention. And then, the beam alignment procedure may be enabled unidirectionally, where one device acts as the transmitter and the other device acts as the receiver during the beam alignment procedure.

In a preferred setup, the subsystem comprises:
a tiltable mirror configured to reflect the incident light to a beam splitter;
the beam splitter configured to selectively direct:
either reflected light from the tiltable mirror to a multi element detector; or
the beam from the light source to the remote optical receiver; the multi element detector configured to:
detect the reflected incident light directed by the beam splitter; and
provide a control signal to steer the tiltable mirror such that the reflected incident light falls in a center of the multi element detector.

The multi element detector is a kind of photo detector comprising more than one detector element. In one example, the multi element detector is a quadrant detector.

Beneficially, the more elements comprised in the multi element detector, the better for assisting the beam alignment procedure. However, the cost of the system may also increase accordingly. Therefore, the selection of multi element detector is a design choice between performance and cost.

Beneficially, the half spherical mirror is semi-transparent and semi-reflective, and the photo detector is placed behind the half spherical mirror with regard to an incident direction of the beam and at the center of the half-sphere.

Advantageously, a portion of the beam that transmits through the half spherical mirror is larger than a remaining portion of the beam that is reflected back to the optical transmitter.

Since only the portion of the beam that transmits through the half spherical mirror contributes to optical data communication while the reflected portion is only used for beam alignment, it is preferred that the portion of the beam that transmits through the half spherical mirror is larger than the remaining portion that is reflected back to the optical transmitter. The ratio between the two portions may be controlled by a type of a coating on the half spherical mirror, a thickness of a coating on the half spherical mirror, or a composition of a coating on the half spherical mirror.

Even more beneficially, the portion of the beam that transmits through the half spherical mirror is at least two times of the remaining portion that is reflected back to the optical transmitter.

Alternatively, the half spherical mirror is reflective, and the photo detector is placed next to the half spherical mirror in proximity such that both the half spherical mirror and the photo detector are in a coverage area of the beam from the optical transmitter.

In this setup, the half spherical mirror is not semi-transparent anymore, but purely reflective, which is placed next to the photo detector. The beam from the optical transmitter shall be sufficiently wide to cover both the half spherical mirror and the photo detector, and the reflective half spherical mirror reflects part of the beam back to the optical transmitter to assist the beam alignment procedure. To reduce the unnecessary energy consumption of the optical transmitter due to the wide beam width, it is beneficial to place the half spherical mirror as close as possible to the photo detector. The photo detector and the half spherical mirror may be mounted on a same surface in the optical receiver.

Advantageously, the light source is configured to emit the beam with a non-uniform intensity in the cross-section, and the intensity is highest at the center.

To assist the beam alignment procedure, it is beneficial to add further information in the beam emitted by the optical transmitter. The further information may be a predefined intensity distribution of the light beam cross-section.

In one setup, the information related to the non-uniform intensity is used by the subsystem to assist the beam alignment procedure.

The beam alignment subsystem in the optical transmitter may compare the intensity distribution of the cross-section in the reflected light with the intensity distribution of the originally emitted beam by the optical transmitter. The orientation of the light source and/or the tiltable mirror, or the entire optical transmitter can then be adjusted according to the comparison result.

Beneficially, the intensity in the cross-section is according to a Gaussian distribution.

In accordance with a second aspect of the invention a method is provided. A method of an optical wireless communication system comprises the steps of:
emitting a beam by an optical transmitter for optical data communication;
reflecting, by a half spherical mirror comprised in a remote optical receiver, part of the beam to assist a beam alignment procedure carried out by the optical transmitter;
carrying out the beam alignment procedure by the optical transmitter based on incident light received from the remote optical receiver;
detecting by the remote optical receiver the beam from the optical transmitter.

In one example, the method further comprises the steps of the optical transmitter:
reflecting the incident light by a tiltable mirror to a beam splitter;
selectively directing by the beam splitter either reflected light from the tiltable mirror to a multi element detector, or the beam to the remote optical receiver;
detecting by the multi element detector the reflected incident light directed by the beam splitter; and
providing a control signal to steer the tiltable mirror such that the reflected incident light falls in a center of the multi element detector;
   wherein the half spherical mirror is semi-transparent and semi-reflective, and a photo detector of the remote optical receiver is placed behind the half spherical mirror with regard to an incident direction of the beam and at the center of the half-sphere.

In accordance with a further aspect of the invention an optical receiver is provided. An optical receiver comprising:
a photo detector configured to detect a beam sent by a remote optical transmitter;
a half spherical mirror configured to reflect part of the beam received from the optical transmitter to assist a beam alignment procedure carried out by the optical transmitter;
wherein the half spherical mirror is semi-transparent and semi-reflective, and the photo detector is placed behind the half spherical mirror with regard to an incident direction of the beam and at the center of the half-sphere.

In accordance with a further aspect of the invention an optical receiver is provided. An optical receiver comprising:
a photo detector configured to detect a beam sent by a remote optical transmitter;
a half spherical mirror configured to reflect part of the beam received from the optical transmitter to assist a beam alignment procedure carried out by the optical transmitter;
wherein the half spherical mirror is reflective, and the photo detector is placed next to the half spherical mirror in proximity such that both the half spherical mirror and the photo detector are in a coverage area of the beam from the optical transmitter.

### BRIEF DESCRIPTION OF THE DRAWINGS

In the drawings, like reference characters generally refer to the same parts throughout the different figures. Also, the drawings are not necessarily to scale, emphasis instead generally being placed upon illustrating the principles of the invention.

FIG. 1 demonstrates a conventional unidirectional beam steering system for optical wireless communication;

FIG. 2 illustrates basic components of an optical transmitter and a remote optical receiver in an optical wireless communication system according to the present invention;

FIG. 3 demonstrates an example of basic components comprised in a beam alignment subsystem of the optical transmitter;

FIG. 4 illustrates one example to implement the optical receiver;

FIG. 5 demonstrates an arrangement of a beam steering system when the optical transmitter and the optical receiver is aligned;

FIG. 6 demonstrates an arrangement of a beam steering system when the optical transmitter and the optical receiver is not aligned;

FIG. 7 illustrates another example to implement the optical receiver and a situation when the beam is aligned;

FIG. 8 illustrates another example to implement the optical receiver and a situation when the beam is unaligned; and

FIG. 9 shows a flow chart of a method of an optical wireless communication system.

### DETAILED DESCRIPTION OF EMBODIMENTS

The embodiments set forth below represent information to enable those skilled in the art to practice the embodiments and illustrate the best mode of practicing the embodiments. Upon reading the following description in light of the accompanying drawings, those skilled in the art will understand the concepts of the disclosure and will recognize applications of these concepts not particularly addressed herein. It should be understood that these concepts and applications fall within the scope of the disclosure.

For optical wireless communication, such as LiFi, it is known that for a certain separation distance between a transmitter and a receiver, much less transmission power is needed if the radiated beam from the transmitter is narrower. As the transmitter beam gets narrower, it is necessary to direct the beam more accurately towards the receiver.

In order to establish a stable communication with a high throughput, both devices need to be facing each other and be properly aligned. This can be quite challenging in practice, due to the combination of a narrow beam and a large separation.

For this purpose, a pilot light can be used, which is located close to the photo detector in the receiver and transmits the pilot light signal back to the transmitter. The pilot light signal may be an out of band signal, which uses a frequency band different from the communication signal. The transmitter will then detect the pilot signal and use the detection information to direct the transmitting beam more accurately towards the receiver.

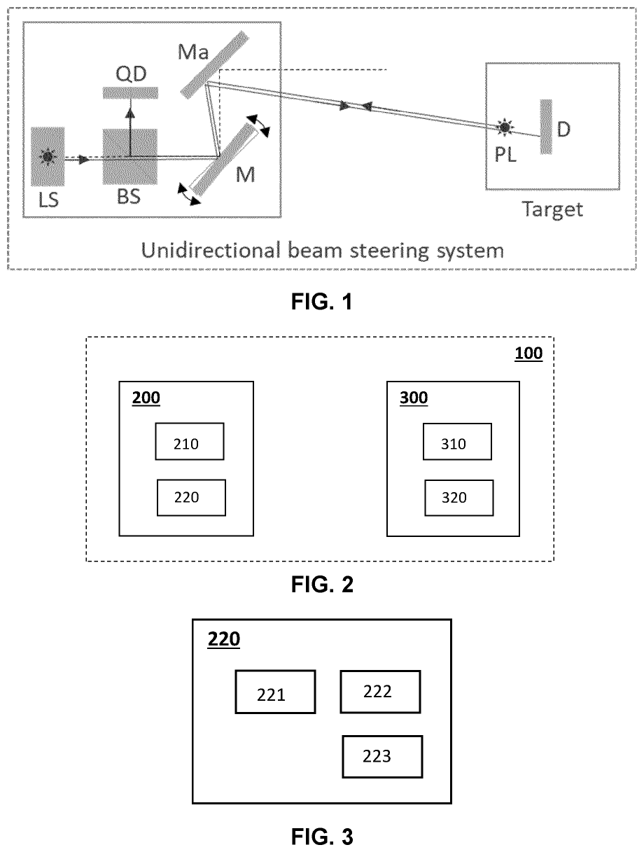

FIG. 1 demonstrates an example of a beam alignment setup based on a pilot light in an optical wireless communication system. The transmitter shown in the block to the left of FIG. 1 comprises a light source (LS), a beam splitter (BS), a quadrant detector (QD), and a beam splitter (BS). The light source (LS) is used to send optical data signals to a remote optical receiver. The tiltable Mirror (M/Ma) is adjustable in both X and Y direction to obtain full coverage in space. The beam splitter (BS) is used to selectively directs the light received the tiltable Mirror (M/Ma) to the quadrant detector (QD) and from the light source (LS) to the remote optical receiver. The remote optical receiver or the target device shown in the block to the right of FIG. 1 comprises at least a photo detector (D) and a pilot light (PL). The photo detector (D) is used to receive optical data signals from the optical transmitter. The pilot light (PL) is used to assist the transmitter to detect the position of the optical receiver or the target device and at the same time to direct the light from the light source (LS) to the photo detector (D) of the target device.

For such pilot light based beam alignment systems, the design challenges are the following:
The surface of the pilot light (PL) must be much smaller than the surface of the photo detector (D), as shown in the figure. In practice this may be difficult to achieve when high data rate is required for the communication link, because the detector (D) (usually photo diode, or avalanche photo diode) must have small surface to obtain low parasitic capacitance, that directly influences the bandwidth of the receiver in the target device.
When the surface of the detector (D) is smaller than the surface of the pilot light (PL), the beam from the light source (LS) must be large enough to cover the detector (D). This limits the beam width to a certain extend determined by the sizes of the pilot light (PL) and the detector (D), and the distance between them.

Given the limitation of the conventional pilot light based system, it is proposed in this invention to deploy a half spherical mirror in the target device to reflect part of the beam received from the transmitter to assist a beam alignment procedure in the transmitter, such that the beam reflected from the target device is used as a kind of pilot light as in a conventional system.

FIG. 2 illustrates basic components of an optical transmitter 200 and a remote optical receiver 300 in an optical wireless communication system 100 according to the present invention. The optical transmitter 200 comprises a light source 210 configured to emit a beam for optical data communication, and a subsystem 220 configured to carry out a beam alignment procedure based on incident light received from the remote optical receiver 300. The remote optical receiver 300 comprises a photo detector 310 configured to detect the beam sent by the optical transmitter 200; a half spherical mirror 320 configured to reflect part of the beam received from the optical transmitter 200 to assist the beam alignment procedure carried out by the optical transmitter 200.

The pair of remote communication devices 200, 300 operate at an optical band, such as in visible light, Ultraviolet (UV), and Infrared (IR) spectra. Point-to-point Li-Fi or optical wireless systems are usually narrow angle systems. The beam angle between two remote receivers is typically not larger than 30 degrees, or 15 degrees half angle. To support high data rate and long distance communication, the beam angle may be in the order of 1 to 5 degrees half-angle and even going up to and including a non-diverging beam. Therefore, it is important to align the beam emitted from the light source 210 of the optical transmitter 200 precisely towards the photo detector 310 of the optical receiver 300.

FIG. 3 demonstrates an example of basic components comprised in a beam alignment subsystem 220 of the optical transmitter 200. The beam alignment subsystem 220 may comprise a tiltable mirror 221, a beam splitter 222, and a multi element detector 223.

The tiltable mirror 221 is configured to reflect the incident light to a beam splitter 222. The beam splitter 222 is configured to selectively direct either the reflected light from the tiltable mirror 221 to a multi element detector 223, or the beam from the light source 210 to the remote optical receiver 300. The multi element detector 223 is configured to detect the reflected incident light directed by the beam splitter 222 and provide a control signal to steer the tiltable mirror 221 such that the reflected incident light falls in a center of the multi element detector 223.

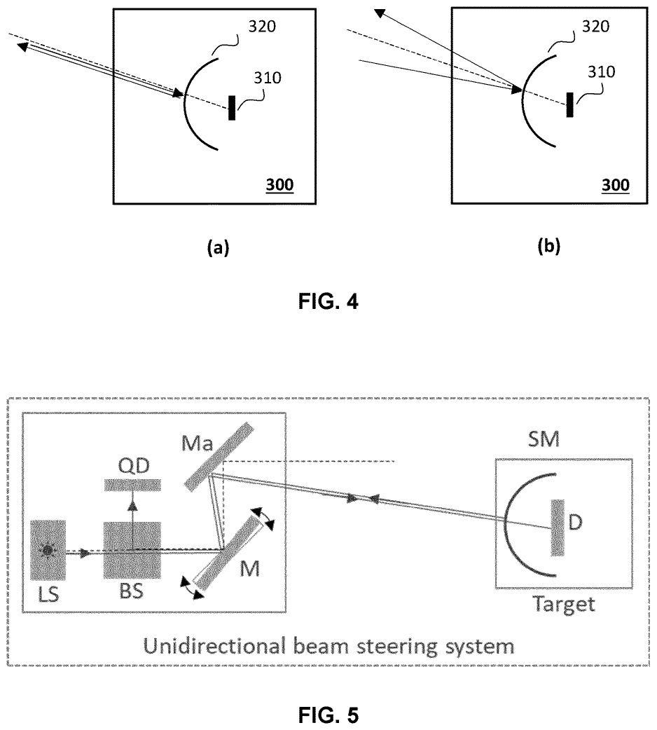

FIG. 4 illustrates one example to implement the optical receiver 300. The half spherical mirror 320 is semi-transparent and semi-reflective, and the photo detector 310 is placed behind the half spherical mirror 320 with regard to an incident direction of the beam and at the center of the half-sphere. The solid lines with arrows represent the injected beam on the mirror 320 and the reflected beam from the mirror 320, with the arrows showing the directions of the beams.

FIG. 4(a) illustrates the scenario that the incident light beam is reflected in the same direction, which gives the indication to the beam alignment subsystem in the optical transmitter that the optical receiver is aligned with the optical transmitter.

FIG. 4(b) illustrates the scenario that the incident light beam is reflected to a different direction, which gives the indication to the beam alignment subsystem in the optical transmitter that the optical receiver is not aligned with the optical transmitter. The optical transmitter will adjust the direction of the output beam accordingly, such as by controlling the tiltable mirror or adjusting the light source, until the subsystem detects that the reflected beam from the optical receiver is in the same direction as the emitted beam.

Note that for this setup the semi-transparent mirror has an accurate spherical shape, and the detector 310 is placed in the center of the half sphere.

FIG. 5 demonstrates an arrangement of a beam steering system according to the present invention when the optical transmitter and the optical receiver is aligned. As compared to the conventional beam alignment setup shown in FIG. 1, the pilot light (PL) in the target is replaced by a semi-transparent mirror (SM) in the shape of a half-sphere. The SM reflects a part of the light beam received from the LS. The light will be reflected to the beam steering unit on the left only when the beam is aligned in a way to directly hit the center of the detector (D) in the optical receiver, which is preferably located in the center of the half sphere. In other cases, the light will be reflected to some other direction, hence no light will come back to be detected at the quadrant detector (QD).

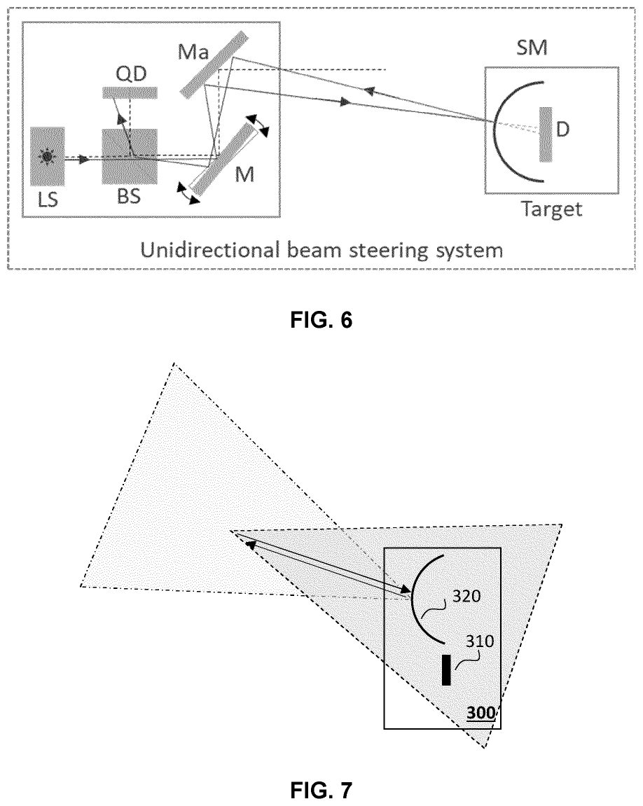

FIG. 6 illustrates the situation when the optical transmitter and the optical receiver is not aligned. In this example, only the beam directed very close to the center of the semi-transparent mirror (SM) will be reflected back to slightly displaced direction to be detected by quadrant detector (QD), which falls off the center of quadrant detector (QD) and this information can be used for fine tuning of the beam direction.

FIG. 7 illustrates another example to implement the optical receiver 300 and a situation when the beam is aligned. In this setup, the half spherical mirror 320 is reflective, and the photo detector 310 is placed next to the half spherical mirror 320 in proximity such that both the half spherical mirror 320 and the photo detector 310 are in a coverage area of the beam from the optical transmitter 200. The solid lines with arrows represent the injected beam on the mirror 320 and the reflected beam from the mirror 320, with the arrows showing the directions of the beams.

The coverage areas of the beam from the optical transmitter and the reflected beam from the optical receiver are illustrated by the triangles with dash lines. In this case, the light beam from the light source shall be sufficiently wide such that when it reaches the optical receiver 300 it covers both the half spherical mirror 320 and the photo detector 310. When the optical transmitter and the optical receiver are aligned, the optical transmitter will also be located in the center of the reflected beam, as shown in FIG. 7.

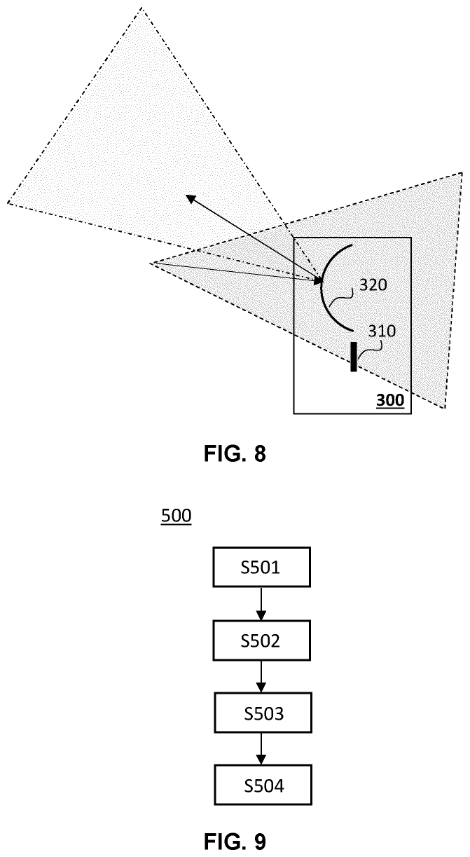

FIG. 8 illustrates a situation when the beam is unaligned. The reflected beam received by the subsystem of the optical transmitter will be even more diverged due to the reflection on the surface of the half spherical mirror 320.

Note that for the setup shown in FIG. 7 and FIG. 8, the accuracy of beam steering may be compromised by the reflected beam width. Preferably, additional information may be added in the beam from the light source to assist the beam alignment procedure.

In one example, the beam from the light source may be configured to be non-uniform in the cross-section but have the highest intensity in the center. This additional information may be used for more accurate beam steering. When the optical transmitter changes slightly the direction of the transmitted beam, the reflected beam will further change the intensity due to the non-uniform intensity. Such information may be used to determine which movement of the light source or the tiltable mirror of the optical transmitter is preferred, and to execute several movements until the maximal intensity is reached, indicating that the optical transmitter and the optical receiver are precisely aligned. One example of the non-uniform cross section can be a kind of Gaussian distribution cross section, which is also easy to implement.

FIG. 9 shows a flow chart of a method 500 of an optical wireless communication system 100. The method 500 comprises the steps of the optical wireless communication system 100:
emitting, in step S501, a beam by an optical transmitter 200 for optical data communication;

reflecting, in step S502, by a half spherical mirror 320 comprised in a remote optical receiver 300, part of the beam to assist a beam alignment procedure carried out by the optical transmitter 200;
carrying out, in step S503, the beam alignment procedure by the optical transmitter 200 based on incident light received from the remote optical receiver 300;
detecting, in step S504, by the remote optical receiver 300 the beam from the optical transmitter 200.

The beam alignment procedure may further comprise the steps of the optical transmitter 200:
reflecting the incident light by a tiltable mirror to a beam splitter;
selectively directing by the beam splitter either reflected light from the tiltable mirror to a multi element detector, or the beam to the remote optical receiver;
-detecting by the multi element detector the reflected incident light directed by the beam splitter; and
providing a control signal to steer the tiltable mirror such that the reflected incident light falls in a center of the multi element detector.

The person skilled in the art realizes that the present invention by no means is limited to the preferred embodiments described above. On the contrary, many modifications and variations are possible within the scope of the appended claims.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. An optical wireless communication system comprising:
an optical transmitter comprising:
a light source configured to emit a beam for optical data communication;
a subsystem configured to carry out a beam alignment procedure based on incident light received from a remote optical receiver and
the remote optical receiver comprising:
a photo detector configured to detect the beam sent by the optical transmitter;
a half spherical mirror configured to reflect part of the beam received from the optical transmitter to assist the beam alignment procedure carried out by the optical transmitter;
wherein the half spherical mirror is semi-transparent and semi-reflective, and the photo detector is placed behind the half spherical mirror with regard to an incident direction of the beam and at the center of the half-sphere.

2. The optical wireless communication system of claim 1, wherein the subsystem comprises:
a tiltable mirror configured to reflect the incident light to a beam splitter;
the beam splitter configured to selectively direct:
either reflected light from the tiltable mirror to a multi element detector or
the beam from the light source to the remote optical receiver;
the multi element detector configured to:
detect the reflected incident light directed by the beam splitter; and
provide a control signal to steer the tiltable mirror such that the reflected incident light falls in a center of the multi element detector.

3. The optical wireless communication system of claim 1, wherein a portion of the beam that transmits through the half spherical mirror is larger than a remaining portion of the beam that is reflected back to the optical transmitter

4. The optical wireless communication system of claim 3, wherein the portion of the beam that transmits through the half spherical mirror is at least two times of the remaining portion that is reflected back to the optical transmitter

5. The optical wireless communication system of claim 1, wherein the light source is configured to emit the beam with a non-uniform intensity in the cross-section, and the intensity is highest at the center.

6. The optical wireless communication system of claim 5, wherein the information related to the non-uniform intensity is used by the subsystem to assist the beam alignment procedure.

7. The optical wireless communication system of claim 5, wherein the intensity in the cross-section is according to a Gaussian distribution.

8. A method of an optical wireless communication system comprising the steps of:
emitting a beam by an optical transmitter for optical data communication;
reflecting by a half spherical mirror comprised in a remote optical receiver, part of the beam to assist a beam alignment procedure carried out by the optical transmitter;
carrying out the beam alignment procedure by the optical transmitter based on incident light received from the remote optical receiver;
detecting by the remote optical receiver the beam from the optical transmitter
wherein the half spherical mirror is semi-transparent and semi-reflective, and a photo detector of the remote optical receiver is placed behind the half spherical mirror with regard to an incident direction of the beam and at the center of the half-sphere.

9. The method of claim 8 further comprising the steps of the optical transmitter
reflecting the incident light by a tiltable mirror to a beam splitter
selectively directing by the beam splitter either reflected light from the tiltable mirror to a multi element detector, or the beam to the remote optical receiver;
detecting by the multi element detector the reflected incident light directed by the beam splitter and
providing a control signal to steer the tiltable mirror such that the reflected incident light falls in a center of the multi element detector

10. An optical receiver comprising:
a photo detector configured to detect a beam sent by a remote optical transmitter;
a half spherical mirror configured to reflect part of the beam received from the optical transmitter to assist a beam alignment procedure carried out by the optical transmitter;
wherein the half spherical mirror is semi-transparent and semi-reflective, and the photo detector is placed behind the half spherical mirror with regard to an incident direction of the beam and at the center of the half-sphere.
